(19) United States
(12) Patent Application Publication
(10) Pub. No.: US 2010/0127493 A1
(43) Pub. Date: May 27, 2010

(54) CONNECTING ARRANGEMENT FOR A PIPE UNION

(76) Inventor: Norbert Felder, Hennef (DE)

Correspondence Address: COLLARD & ROE, P.C., 1077 NORTHERN BOULEVARD, ROSLYN, NY, 11576, US

(21) Appl. No.: 12/452,157

(22) PCT Filed: Jun. 18, 2007
(86) PCT No.: PCT/EP2007/056018

§ 371 Date: Dec. 30, 2009

(51) Int. Cl. F16L 25/00

(52) U.S. Cl. 285/389

(57) ABSTRACT

A connecting arrangement connects a cylindrical pipe (10) or a pipe section to a connecting body (20). The connecting body (20) has a first conical bore (23), extending away from a face (24), a first cylindrical bore (21) for receiving the pipe (10), which bore is contiguous to the conical bore (23), and a second cylindrical bore (22) that is contiguous to the first cylindrical bore (21) and the diameter of which is reduced. A union nut (30) has a bore (31) for the pipe (10) or the pipe section. The union bore has a threaded section (38) by means of which the union nut (30) can be screwed onto a mating threaded section (28) of the connecting body (20), and a conical bore (33) that tapers in a direction opposite to that of the conical bore (23) of the connecting body (20). Adjacent to the end of the pipe (10) or the pipe section a zone (11) of the pipe (10) bulges outward all around and has a tensioning face (12) that interacts with the conical bore (33) of the union nut (30) and is complementary thereto. An intermediate ring (50) has a bore (51) for the pipe (10) or the pipe section. The intermediate ring (50) is interposed between the zone (11) of the pipe (10) that bulges outward all around and the connecting body (20). It is supported on the face (24) of the connecting body (20).

The invention relates to a connecting arrangement for connecting a cylindrical pipe or pipe section to a connecting body, whereby the connecting body has a first conical bore that proceeds from a face surface, a first cylindrical bore that follows the conical bore, to accommodate the pipe, and a second cylindrical bore that follows the first cylindrical bore and is reduced in diameter, with a union nut that has a bore for the pipe or pipe section, with a thread with which the union nut can be screwed onto a counter-thread of the connecting body, and with a conical bore that narrows opposite to the conical bore of the connecting body, with a region of the pipe provided adjacent to the end of the pipe or pipe section that bulges outward all around, which bulged-out region has a bracing surface that interacts with the conical bore of the union nut and is configured as a mirror image of this conical bore.

Pipe unions are supposed to become possible with such connecting arrangements. In this connection, a pipeline, particularly a metallic one, is supposed to be connected to a connecting piece that has an accommodation opening for the pipeline. The pipeline has a region that bulges outward all around, adjacent to its end. It is therefore formed here, generally swaged.

A union nut that can be screwed together with the connecting piece can be rotated when this formed pipeline end is connected, and thus exerts an axial movement onto this bulged-out region that is situated between the union nut and the connecting piece. A conical bore situated in the union nut, which is configured as a mirror image of the bracing surface of the bulged-out region, then ensures that the bulged-out region is drawn onto the connecting piece and is held tightly there in screwed-on form.

Such a concept is known, for example, from DE 195 11 063 C2. In this connection, the bulged-out region of the pipe contains passages, on the one hand, that contain mirror-image bracing surface of the cone angle of the union nut, as well as other cone-shaped regions that support themselves on the conical bore of the connecting piece, in order to allow a secure hold there, as well. In individual embodiments, it is furthermore proposed to dispose seals in various forms in the remaining free spaces between the outer wall of the pipe, the inner wall of the union nut, and the upper face surface of the connecting piece; these seals lie around the pipe in ring shape or disk shape.

Another pipe union with a ring bead on a pipeline, which bead surrounds the connecting end, is known from DE 101 24 874 A1. There, a ring-shaped circumferential seal is introduced into a region in the conical bore in the connecting piece, whereby the ring bead is also introduced into this conical bore, so that there, the most reliable sealing possible can take place. Furthermore, a circumferential support ring is laid in between union nut and the ring bead, in order to prevent the pipe from being turned during assembly, and to be able to use a standardized union nut at different inclines.

It is problematic that either great interventions in the inside diameter of the pipe end have to be undertaken, or that inaccuracies in the assembly and/or disadvantageous influences of force can occur when the individual elements are joined together.

In contrast with this, it is the task of the invention to propose a connecting arrangement for connecting cylindrical pipes of pipe sections to a connecting body, which allows a more advantageous flow of force during the assembly process.

This task is accomplished, in the case of a connecting arrangement of the stated type, according to the invention, in that an intermediate ring is provided, that the intermediate ring has a bore for the pipe or pipe section, that the intermediate ring is disposed between the region of the pipe or pipe section that bulges outward all around and the connecting body, and that the intermediate ring supports itself on the face surface of the connecting body.

The task is surprisingly accomplished in this way. By means of providing an intermediate ring having precisely the defined properties, it becomes possible to separate the individual functions that, in the final analysis, have to be guaranteed by the connecting arrangement, from one another. This particularly relates to the sealing function, which can be completely separated from the actual connecting process, in which separate properties are assigned to the components.

In contrast to DE 101 24 874 A1, it is also no longer necessary to seal two conical surfaces relative to one another, since the entire bulged-out region no longer has to project into the conical bore of the connecting piece, but rather, supports itself on the outside, on the intermediate ring disposed in between.

The intermediate ring not only allows separation of the different functions of the connecting arrangement, but also allows contact limitation of the pipe. In the state of the art, it was not precisely defined up to what point the lower end of the pipe can penetrate when it is connected to the connecting piece. In some cases, the inner face surface of the connecting piece was simultaneously the contact limitation, and this could lead to over-assembly.

According to the invention, however, the intermediate ring leads to the result that a play between this face surface and the lower end of the pipe, which play is intentionally kept small, can be aimed at, and this can also be utilized for balancing out production tolerances in the production of the bulged-out region.

Furthermore, it is possible, in a preferred embodiment, to integrate a soft seal into the connecting arrangement, and to allow this soft seal to be carried by the intermediate ring. In this connection, this soft seal can also be spatially separated from the bulged-out region. It is furthermore particularly advantageous if the connecting arrangement is configured in such a manner that the region that bulges outward all around has a rest surface on its side that faces away from the conical bore of the union nut, that the intermediate ring has a support surface for this rest surface, and that the rest surface and the support surface are configured as mirror images.

In this connection, it is particularly interesting to configure the rest surface in such a manner that its incline amounts to between 10° and 15°, particularly 11° relative to the horizontal, whereby this incline is directed upward, in the direction toward the pipe axis, in other words an undercut behind the bulged-out region of the pipe is formed.

In this manner, it becomes possible to achieve an improved distribution and direction of effect of the forces that occur.

Ideally, the force that acts on the pipe would stand vertically on the bracing surface of the union nut. In the case of conventional unions, however, the force usually stands at a 45° angle on this surface. According to the invention, however, a reduction of this angle to 30 to 35° is possible, thereby reducing the radial component of the force.

The preferred angle on the order of 10 to 15° is preferred because even greater angles can be implemented only with significant mechanical effort, and the angle now preferred represents a particularly skillful compromise between the angles that are technically aimed at and those that are feasible.

The angles allow a relatively homogeneous flow of force.

Over-assembly of the system is reliably prevented by the preferred arrangement of the intermediate ring. Furthermore, the operator is given a clear signal once the pipe to be connected has set itself down onto the connecting piece by way of the intermediate ring, and thus an optimal connection has been achieved.

The change in the inside contour of the pipe in the bulged-out region is minimal. As a result, the flow is hindered as little as possible. As a result, noise development is countered with particular prospects of success.

The force required for forming the pipe is also reduced, since the configuration of the bulged-out region as described can be achieved with relatively little force.

An exemplary embodiment of the invention will be explained in greater detail in the following, using the drawing. This shows:

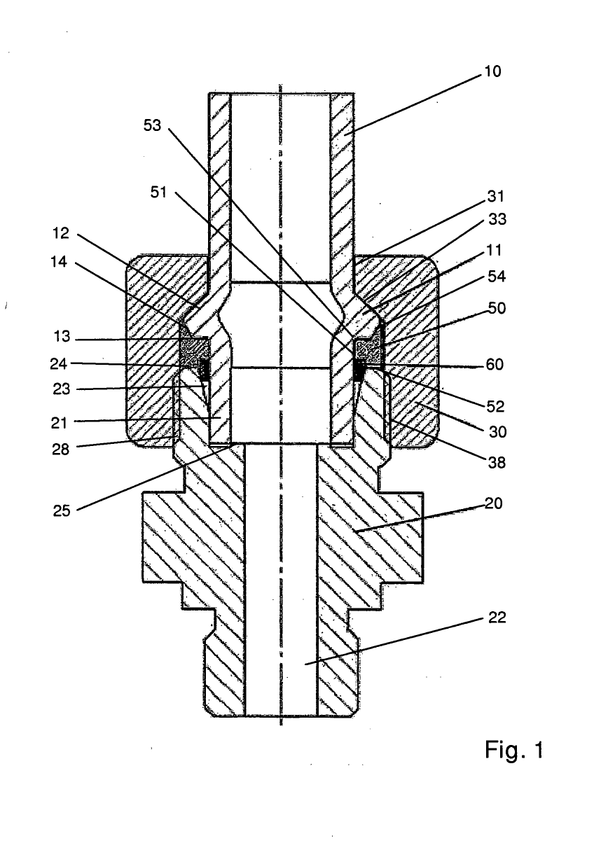

FIG. 1 a section through an embodiment of a connecting arrangement according to the invention;

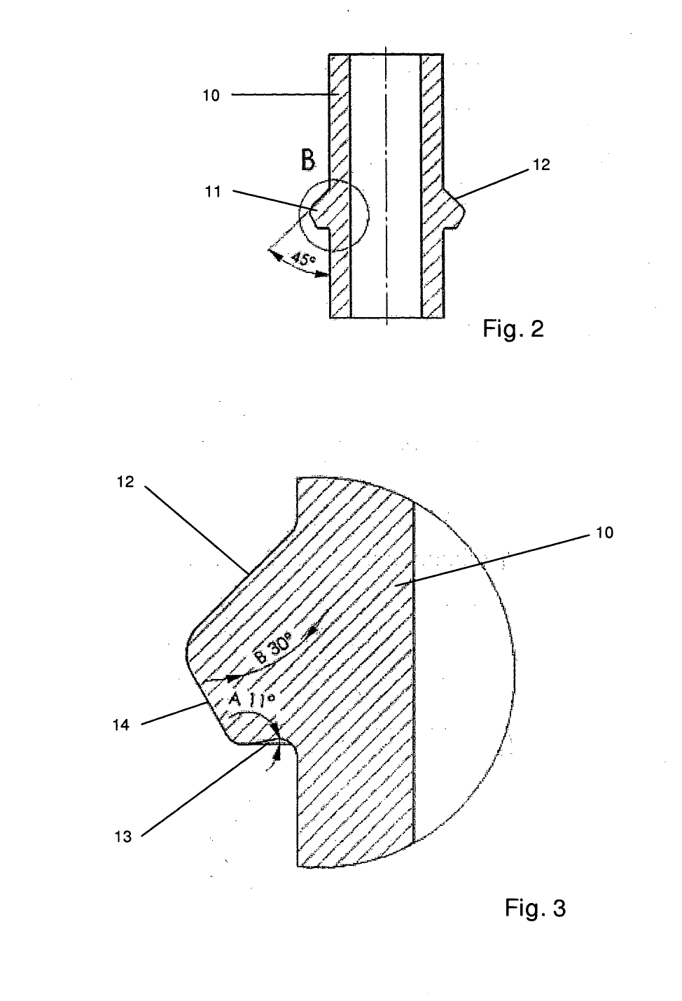

FIG. 2 a representation of an element from FIG. 1 for a more detailed explanation; and

FIG. 3 an enlarged representation of a detail from FIG. 2.

A pipe union of a pipe 10 with a connecting body 20 is explained in greater detail in FIG. 1. The pipe 10 is cylindrical; in FIG. 1, a lower end of the pipe 10, which can be significantly longer and could also be part of a pipeline arrangement, is shown as an example.

This pipe 10 is inserted into a connecting body 20. For this purpose, the connecting body 20 possesses a first cylindrical bore 21, which is precisely dimensioned so that the pipe 10 can be inserted there. A second bore 22 is provided with a smaller diameter. This second bore 22 continues the first bore in the direction of the interior of the connecting body 20. A medium situated in the interior of the pipe 10 can thus get into the second bore 22 and be conveyed further there.

Furthermore, a face surface 25 is provided, which separates the first bore 21 and the second bore 22 from one another.

Another face surface 24 is provided as the outer surface of the connecting body 20; in this connection, the first, outer cylindrical bore 21 makes a transition into a conical bore 23 that opens in the direction of the face surface 24.

On the outside, the connecting body 20 also has a thread 28, which is equipped for forming a screw connection with a counter-thread 38 that will still be described further in the following.

Specifically, a union nut 30 having this counter-thread 38 can be screwed onto the thread 28 of the connecting body 20. The union nut 30 possesses a bore 31 through which the pipe 10 can be guided. Between the bore 31 and the thread 38, another section is provided, in which the bore through the union nut 30 widens in the direction toward the connecting body 20, as a conical bore 33.

In this region, the pipe 10 possesses a region 11 that bulges outward all around, adjacent to its end. This bulged-out region 11 is achieved by swaging the pipe. The inside diameter of the pipe 10 can be expanded slightly in the region 11, as can be seen in FIG. 1. The region 11 that bulges outward all around is configured uniformly on the entire circumference of the pipe 10.

The bulged-out region possesses a bracing surface 12 that matches the conical bore 33 of the union nut 30 and is configured as a mirror image to it on its side facing away from the connecting body 20. This bracing surface 12 is therefore also configured conically and widens downward in the direction of the connecting body 20.

Seen from the lower side of the pipe 10, the region 11 that bulges outward all around is at first equipped with a surface that is horizontal, in a first approximation, namely a rest surface 13, which will be described in greater detail further below. This rest surface 13 then makes a transition into a conical support surface 14.

An intermediate ring 50 is disposed between the region 11 of the pipe 10 or pipe section that bulges outward all around and the connecting body 20. This intermediate ring 50 also possesses a bore 51 for the pipe 10 and surrounds this pipe 10. The intermediate ring 50 can also be referred to as an adapter element or as a holding ring.

This intermediate ring 50 possesses a circumferential support surface 52 with which it lies on the face surface 24 of the connecting body 20.

Furthermore, the intermediate ring 50 possesses a conical bore 53 adjacent to the bore 51. The bulged-out region 11 sits on the intermediate ring 50 with its rest surface 13 in this conical bore 53.

The conical bore 53 in turn borders on and makes a transition into another conical bore 53 of the intermediate ring 50, which lies opposite the conical surface 14 of the bulged-out region, as a mirror image.

The intermediate ring 50 furthermore carries a soft sealing element 60. This soft sealing element 60 is situated between the outer wall of the pipe 10, the conical bore 23 of the connecting body 20, and a corresponding carrying device of the intermediate ring 50. Since the intermediate ring 50 also borders on the outer wall of the pipe 10, the soft sealing element 60, which also runs around the pipe 10, is permanently mechanically separated from the region 11 that bulges outward all around.

FIG. 2 shows the lower section of the pipe 10, which is relevant here, separately once again. In this connection, the inner bore of the pipe 10 is assumed to have a constant diameter, in contrast to FIG. 1.

The region 11, which bulges outward all around, can be clearly seen. This region 11 is delimited in the upward direction by a conical bracing surface 12. The surface of this conical bracing surface 12 encloses an angle of approximately 45° with the vertical, axis-parallel wall of the pipe 10, as can be seen in FIG. 2.

The region 11 of the pipe 10 that bulges outward all around is shown once again in FIG. 3, enlarged, as Detail B.

Aside from the bracing surface 12, here one can also see that the underside of the region 11 that bulges outward all around is taken up by a rest surface 13. This rest surface 13 runs approximately, but preferably not precisely perpendicular to the axis-parallel wall of the pipe 10. Upon close inspection, it encloses an angle of about 10 to 15°, in the preferred embodiment shown of 11°, with this perpendicular. In this connection, this rest surface 13 again is configured to be conical, overall, whereby the conicity is oriented in the same orientation as the conical bracing surface 12, but, as has been mentioned, possesses a different cone angle.

In this connection, attention is paid, in all cases, to ensure that the cone surfaces make a rounded transition into the adjacent surfaces, and that no pointed edges are provided.

A conical surface 14, which also runs all around, is provided between the two cone-shaped surfaces 12 and 13 that possess the same orientation.

Aside from the angle A of 11°, which the rest surface 13 encloses with the horizontal, an angle B of 30° is also shown. The angle B reproduces the force progression at which 30° represents a difference component.

### REFERENCE SYMBOL LIST

10 pipe (cylindrical)

11 region of the pipe bulging outward all around

12 bracing surface

13 rest surface

14 conical surface

20 connecting body

21 bore (first cylindrical bore for the pipe 10)

22 bore (second, having a smaller diameter)

23 conical bore

24 face surface, against the intermediate ring

25 face surface, against the pipe 10

28 thread for screw connection with union nut 30

30 union nut

31 bore for the pipe 10

33 conical bore

38 thread for screw connection with connecting body 20

50 intermediate ring

51 bore for pipe 10

52 support surface against connecting body 20

53 cone relative to rest surface 13 of region 11

54 cone relative to conical surface 14 of region 11

60 soft sealing element

1. Connecting arrangement for connecting a cylindrical pipe (10) or pipe section to a connecting body (20),
whereby the connecting body (20) has a first conical bore (23) that proceeds from a face surface (24), a first cylindrical bore (21) that follows the conical bore (23), to accommodate the pipe (10), and a second cylindrical bore (22) that follows the first cylindrical bore (21) and is reduced in diameter,
with a union nut (30) that has a bore (31) for the pipe (10) or pipe section, with a thread (38) with which the union nut (30) can be screwed onto a counter-thread (28) of the connecting body (20), and with a conical bore (33) that narrows opposite to the conical bore (23) of the connecting body (20),
with a region (11) of the pipe (10) provided adjacent to the end of the pipe (10) or pipe section that bulges outward all around, which bulged-out region (11) has a bracing surface (12) that interacts with the conical bore (33) of the union nut (30) and is configured as a mirror image of this conical bore (33),
wherein
an intermediate ring (50) is provided,
wherein the intermediate ring (50) has a bore (51) for the pipe (10) or pipe section,
wherein the intermediate ring (50) is disposed between the region (11) of the pipe (10) or pipe section that bulges outward all around and the connecting body (20),
wherein the intermediate ring (50) supports itself on the face surface (24) of the connecting body (20),
wherein the region (11) of the pipe (10) that bulges outward all around has a rest surface (13) on its side that faces away from the conical bore (33) of the union nut (30),
wherein the intermediate ring (50) has a support surface (54) for this rest surface (13),
wherein the rest surface (13) and the support surface (54) are configured as mirror images,
wherein the rest surface (13) has a circumferential section in which it is inclined conically in the same direction relative to the conical bore (33),
whereby the incline of the rest surface (13) of the intermediate ring (50) amounts to between 10° and 15° to the horizontal.

2. Connecting arrangement according to claim 1,
wherein
the intermediate ring (50) has a soft sealing element (60), and wherein the soft sealing element (60) is disposed between the wall of the pipe (10), the intermediate ring (50), and the conical bore (23) of the connecting body (20), surrounding the pipe (10).

3. Connecting arrangement according to claim 1, wherein
the dimension of the intermediate ring (50) in the axial direction is dimensioned in such a manner that when a pipe (10) or pipe section is connected with the connecting body (20) using the connecting arrangement, the intermediate ring (50) supports itself on the face surface (24) of the connecting body (20) with a support surface (52), while the end of the pipe (10) or pipe section still has some play in the connecting body (20), relative to the end of the cylindrical bore (21).

4-6. (canceled)

7. Connecting arrangement according to claim 1, wherein
the region (11) of the pipe (10) that bulges outward all around furthermore makes a transition, from the rest surface (13), into a second cone (14),
wherein the cone angle of the second cone (14) of the bulged-out region (11) and a cone angle of a conical bore (53) of the intermediate ring (50) are configured as a mirror image, in each instance, and run with the same orientation but possibly a different orientation relative to the conical bore (23) of the connecting body (20).

8. Connecting arrangement according to claim 7,
wherein
the cone angle of the second cone (14) of the region (11) of the pipe (10) or pipe section that bulges outward all around and the cone angle of the conical bore (53) of the intermediate ring (50) amount to more than 20°, particularly about 30° (±5°).
